(19) United States
(12) Patent Application Publication
(10) Pub. No.: US 2024/0234692 A1
(43) Pub. Date: Jul. 11, 2024

(54) METHOD FOR THE PREPARATION OF A MATERIAL COMPRISING SILICON NANOWIRES AND TIN

(71) Applicant: ENWIRES, Montbonnot-Saint-Martin (FR)

(72) Inventor: Florian D'ACCRISCIO, Domène (FR)

(73) Assignee: ENWIRES, Montbonnot-Saint-Martin (FR)

(21) Appl. No.: 18/573,617

(22) PCT Filed: Jun. 22, 2022
(86) PCT No.: PCT/EP2022/066950

§ 371 Date: Dec. 22, 2023

(30) Foreign Application Priority Data
Jun. 24, 2021 (EP) 21305870.4

(51) Int. Cl. H01M 4/36; B01J 21/18; B01J 27/135; C01B 33/029; H01M 4/134; H01M 4/1395; H01M 4/38; H01M 10/0525

(52) U.S. Cl. CPC H01M 4/364; B01J 21/18; B01J 27/135; C01B 33/029; H01M 4/134; H01M 4/1395; H01M 4/386; H01M 4/387; H01M 10/0525; C01P 2004/03; C01P 2004/16; C01P 2006/40

(57) ABSTRACT

A method for the preparation of a composite material including at least silicon nanowires and tin, the method including the use of a tin halide, as a catalyst for preparing silicon nanowires.

The invention is directed to a method for the growth of silicon nanowires using a tin (II) halide, preferably tin (II) chloride, as a metallic seed precursor. The method is cheap and robust, it proceeds at moderate temperature and allows control of silicon nanowires diameter. It is implemented in the presence of a growth support. Silicon nanowire-based composites, prepared by this method, can be used in various applications such as nano- and micro-electronics, spintronics, energy conversion and scavenging, sensors or anode material for lithium-ion batteries.

### STATE OF THE ART

Silicon, as a high earth abundant element with exceptional characteristics, is one of the centerpieces for many high-tech applications. Indeed, silicon is one of the leading components within solar cells technology as well as in microelectronics. Silicon has a low discharge potential and a very high theoretical charge capacity (>4000 mA.h.g⁻¹), that make it very interesting for applications in Li-ion batteries. One of the other advantages of silicon is the possibility to modify its morphology via nano-structuration. Indeed, silicon is available as 0D (nanoparticles), 1D (nanowires), 2D (nanosheets) morphologies. The nano-structuration of silicon is known to improve its capacity to withstand mechanical strains occurring during the lithiation/de-lithiation process.

Among these morphologies, silicon nanowires (SiNWs) have attracted a lot of attention for their very high aspect ratio favoring efficient charge transport which is particularly beneficial for their application as anodes in Li-ion batteries.

In addition, their electrical conductivity can be easily improved by dopants which can extend their applications to supercapacitors (1, 2) and thermo-electrics (3).

Different techniques for SiNWs production are categorized mainly in two synthetic approaches: bottom-up (nanowire growth from elemental silicon) and top-down (etching of bulk silicon). Top-down approach is characterized by considerable waste of starting silicon and inevitable use of hazardous chemicals. Bottom-up technique, generally based on chemical vapor deposition (CVD), can produce high quality nanowires. This method is favored to produce composites of silicon nanowires and graphite/carbon. Industrial fabrication at acceptable price of such composites is an important challenge for battery market.

The synthesis of SiNWs did not evolve much since the 60s and the description of the bottom-up production of SiNWs by the vapor-liquid-solid (VLS) mechanism. Nowadays, the VLS is the most prominent and efficient method to synthesize SiNWs. More precisely, the VLS manufacturing process mainly focusses on the combination of a substrate, such as silicon wafer (2D), silicon or carbon nanoparticles (0D) and a growth seed usually in the form of a thin metallic film or nanoparticles.

Gold nanoparticles (Au NPs) are known as one the best seed for SiNWs growth. Indeed, the Au—Si binary phase diagram shows a first eutectic point at 363° C. This low eutectic point allows the reaction to be carried out at relatively low temperature (compared to the melting point of gold around 1100° C.) and to be mostly driven by the temperature decomposition of the silane precursor.

The AuNPs “catalyzed” Si wire growth is usually performed by chemical vapor deposition (CVD) using a silicon precursor such as silane or diphenylsilane. However, this synthesis is exclusively performed at a laboratory scale for limited SiNWs quantities. Indeed, the “in-house” production of AuNPs is time consuming, expensive and could be difficult to scale up. This strategic material would be too expensive to allow economically viable mass production of SiNWs.

Other metals promote VLS mechanism and present a low eutectic point with silicon and no silicide phase in their binary phase diagram. For instance, Tin, Gallium, Cadmium, Indium, Strontium, Tellurium and Lead present this property. Among them, tin is earth abundant and presents one of the lowest eutectic point at 232° C.

Jeon et al. (4) reported the tin-seeded SiNWs synthesis by Plasma enhanced chemical Vapor deposition (PECVD) for solar cells application. A thin film of Sn (0) was deposited in situ onto a Si wafer by a thermal evaporation of metallic tin. SiNWs growth was then controlled by the introduction of a hydrogen/SiCl₄ gas flow.

Ball et al. (5) disclosed the use of Sn (0) nanoparticles (NPs) as catalyst for the growth of SiNWs, using silane as silicon source at low pressure.

Dai et al. (6) disclosed the use of tin (II) dioxide nanoparticles (SnO₂ NPs) as the source of tin catalyst. In a first step, the reduction of SnO₂ NPs to Sn (0) NPs is performed, followed by the introduction of silane at 400° C. to synthesize silicon nanowires.

Ngo et al. (7) disclosed the plasma enhanced reduction of ITO at 250° C. leading to the agglomeration of the metal into catalyst droplets of Tin (0) and Indium (0). These droplets allow silicon nanowires growth at 500° C. in the presence of silane.

Chockla et al. (8) described the use of bis(bis(trimethylsilyl)amino)tin (Sn(HMDS)2). Supercritical fluid-liquid-solid synthesis was performed allowing in situ formation of Sn(0) seed particles followed by direct SiNWs growth using trisilane at 450° C.

If these examples demonstrate that tin is an interesting candidate as seed for the growth of Si NWs, these materials remain expensive and do not allow a large production of Si NWs.

In the state of the art, SnCl₂ has been used as a precursor for tin-seeded SiNWs growth. For instance, Gerrard E. J. Poinern et al. (9) reported the use of the reverse micelle method for the reduction of a tin salt to produce metallic Sn nanoparticles as seeds for the growth of SiNWs. Once Sn NPs were formed, silicon nanowires (SiNWs) were grown using PECVD. Even though this method of preparation is quite elegant, it shows its limits as it involves numerous steps, is quite expensive and time-consuming.

A robust and economically viable technology for mass production of SiNWs is required to bring this unique and relevant material to several industrial applications.

The present invention describes a method for the growth of silicon nanowires using a tin (II) halide, preferably tin (II) chloride, as a metallic seed precursor. The method is simple, cost-efficient and robust. It uses in-situ transformation of a tin (II) halide, preferably tin (II) chloride, to tin nanoparticles at moderate temperature. It also allows a satisfactory control of silicon nanowire diameter.

### SUMMARY OF THE INVENTION

A first object of the invention consists in a method for the preparation of a composite material comprising at least silicon nanowires and tin, said method comprising at least the following stages:
(1) introducing into a chamber of a reactor at least:
   a tin halide SnX₂, with X selected from: F, Cl, Br, I, and
   a growth support,
(1′) solid/solid mixing of the tin halide SnX₂ and the growth support,
(2) introducing, into the chamber of the reactor, at least one precursor compound of the silicon nanowires,
(3) decreasing the dioxygen content in the chamber of the reactor,
(4) applying a thermal treatment at a temperature ranging from 200° C. to 900° C., and
(5) recovering the product,

Wherein steps (1), (1′), (2), (3), and (4) can be implemented in this order or in another order.

The invention also relates to a method of making an electrode including a current collector, said method comprising (i) implementing the method disclosed above to prepare a composite material comprising at least silicon nanowires and tin, as an electrode active material, and (ii) covering at least one surface of the current collector with a composition comprising said electrode active material.

The invention also relates to a method of making an energy storage device, like a lithium secondary battery, including a cathode, an anode, and a separator disposed between the cathode and the anode, wherein at least one of the electrodes, preferably the anode, is obtained by above disclosed method.

According to a first variant, the method for the preparation of a composite material is implemented in a fixed-bed reactor.

According to a second variant, the method for the preparation of a composite material is implemented in the tubular chamber of a tumbler reactor set in motion by a rotating and/or a mixing mechanism.

According to a favourite embodiment, the tin halide is SnCl₂.

According to a favourite embodiment, the tin halide and the growth support are mixed together before their introduction into the reactor.

According to a favourite embodiment, the thermal treatment is performed at a temperature ranging from 200° C. to 900° C., preferably from 300° C. to 650° C.

According to a favourite embodiment, the thermal treatment is applied from 1 minute to 5 hours, preferably from 10 minutes to 2 hours, and more preferably from 30 minutes to 60 minutes.

According to a favourite embodiment, the method for the preparation of a composite material comprises a post-treatment step in order to transform organics, in particular organics resulting from the precursor compound of the silicon nanowires, into carbon materials.

According to a favourite embodiment, the method for the preparation of a composite material comprises an additional step (6) of treating the composite material obtained at the end of step (5) with an acidic solution.

According to a favourite embodiment, the precursor compound of the silicon nanowires is a silane compound or a mixture of silane compounds.

According to a favourite embodiment, the precursor compound of the silicon nanowires is silane (SiH₄) or diphenylsilane Si(C₆H₅)₂H₂.

According to a favourite embodiment, the growth support is a carbon-based material, a silicon-based material, an ITO based material, a carbonaceous polymer.

The method according to the invention is based on the use of a tin halide, preferably SnCl₂, as a catalyst for the preparation of SiNWs. It is advantageous in that it can be carried out in a one-pot reaction without pre-treatment of the catalyst.

The invention is implemented in the presence of a growth support.

The combination of the tin halide, preferably SnCl₂, and the growth support is simple and robust. Using a very stable product as SnCl₂, or another tin halide, allows an easy processing. Indeed, SnCl₂ and the other tin halides only require solid/solid mixing with the growth support. Methods in which SiNWs growth is based, for example, on gold nanoparticles require a solid/liquid preparation, followed by an evaporation of solvents. The method according to the invention has the advantage of being implemented without any pre-treatment and without any solvent.

It is possible to control the nanowires' diameters by the appropriate selection of the growth support physical properties. As illustrated in the examples, the diameters of nanowires prepared using SnCl₂ are directly impacted by the growth support characteristics.

### DETAILED DESCRIPTION

The term “consists essentially of” followed by one or more characteristics, means that may be included in the process or the material of the invention, besides explicitly listed components or steps, components or steps that do not materially affect the properties and characteristics of the invention.

The expression “comprised between X and Y” includes boundaries, unless explicitly stated otherwise. This expression means that the target range includes the X and Y values, and all values from X to Y.

A first object of the invention consists in a method for the production of a composite material comprising silicon nanowires through a chemical vapor deposition (CVD) based process. Said composite material is suitable for use as anode active material in lithium-ion batteries, while other uses are conceivable.

SiNWs composite materials obtained by this method can be used as produced, or can be submitted to post-production treatments.

The present invention relates to a process for the preparation of a silicon-based nanostructured material. It relates to a process for the preparation of a silicon-based composite material comprising at least nano-structured silicon material, tin, and a growth support material, and obtained from the chemical decomposition of a reactive silicon-containing gas species. The process is based on the chemical vapor deposition (CVD) principle.

The term “nanostructured material” is understood to mean, within the meaning of the invention, a material containing free particles, possibly in the form of aggregates or in the form of agglomerates, among which at least 5% by weight of said particles, with respect to the total weight of the material, have at least one of their external dimensions ranging from 1 nm to 100 nm, preferably at least 10%.

By “composite material”, we refer to a material made of at least two constituent materials with significantly different physical or chemical properties.

The external dimensions of the particles may be measured by any known method and notably by analysis of pictures obtained by scanning electron microscopy (SEM) of the composite material according to the invention.

### The Process for the Preparation of the Composite Material

The invention relates to a process for the preparation of a composite material comprising at least tin and SiNWs, the method comprising at least the following steps:
(1) introducing into a chamber of a reactor at least:
   a tin halide Sn(X)₂ with X selected from F, Cl, Br, I, preferably the tin halide is tin chloride SnCl₂, and
   a growth support,
(1′) solid/solid mixing of the tin halide SnX₂ and the growth support,
(2) introducing, into the chamber of the reactor, at least one precursor compound of the silicon nanowires,
(3) decreasing the dioxygen content in the chamber of the reactor,
(4) applying a thermal treatment at a temperature ranging from 200° C. to 900° C., and
(5) recovering the product.

The order of steps (1) to (4) can be the recited order or another order, depending essentially on: the characteristics of the reactor in which the method is implemented, the method for reducing dioxygen content and the state (liquid or gaseous) in which the precursor compound of the silicon nanowires is introduced into the reactor.

According to a first variant, the method is implemented in a fixed-bed reactor.

According to a second variant, the method is implemented in the tubular chamber of a tumbler reactor comprising a rotating and/or a mixing mechanism.

Preferably, the reactor is closed during the process.

By closed reactor is meant the introduction of gaseous species into the reactor is achieved at the beginning of the process and then the reactor is closed to gas flow during the thermal treatment step.

### Process Parameters

Process parameters which are reported here-under are common to all variants of the method (fixed-bed reactors, tumbler reactors with a rotating and/or a mixing mechanism).

The process according to the invention comprises the introduction of a growth support into the chamber of the reactor. The nature and characteristics of the growth support are detailed here-under.

The process according to the invention comprises a preliminary step of solid/solid mixing the growth support material with the tin halide SnX₂, here-after the catalyst.

According to a first variant, the SnX₂ catalyst (X═F, Cl, Br, I), preferably SnCl₂, and the growth support are mixed together before their introduction into the reactor.

According to a second variant, the SnX₂ catalyst (X═F, Cl, Br, I), preferably SnCl₂, and the growth support are mixed together in the chamber of the reactor after their introduction as separate raw materials into the reactor.

Step (3) consisting in decreasing the dioxygen content in the chamber of the reactor can be performed by different methods.

Decreasing the dioxygen content in the chamber of the reactor can be implemented by placing the reactor under vacuum, preferably to a pressure inferior or equal to 10⁻¹ bar (10⁻² MPa).

Alternately, decreasing the dioxygen content in the chamber of the reactor can be performed by washing the chamber of the reactor with an inert gas.

In the context of the invention, the expression “washing the chamber of the reactor with an inert gas” means that an inert gas flow is injected into the chamber of the reactor in order to replace the gas present in the reactor by the injected inert gas.

Preferably, the inert gas is chosen from dinitrogen N₂, Argon Ar, and mixtures thereof.

Preferably, the chamber of the reactor is washed at least twice, more preferably at least 3 times with inert gas.

Preferably, at the end of step (3), the dioxygen content in the chamber of the reactor is inferior or equal to 1% by volume, with respect to the total volume of the chamber of the reactor.

Preferably, the thermal treatment is performed at a temperature ranging from 200 to 900° C., preferably from 300° C. to 700° C., even more preferably from 300° C. to 650° C.

Preferably, the thermal treatment is performed under low pressure, atmospheric pressure or pressure ranging from 0.11 to 30 MPa, the pressure parameter being governed by the choice of the type of reactor.

During the process according to the invention, and because of the thermal treatment, the pressure in the reactor may increase. This internal pressure depends on the thermal treatment that is applied and is not necessarily controlled or monitored.

Preferably, the thermal treatment is applied from 1 minute to 5 hours, preferably from 10 minutes to 2 hours, and more preferably from 30 minutes to 60 minutes.

According to a variant embodiment, the process according to the invention comprises a post-treatment step, between steps (4) and (5), in order to transform organics into carbon materials. By “organics” it is meant organic chemical residues resulting from the decomposition of the silicon nanowire precursor, in particular silanes and/or diphenylsilane. When it is implemented, this step consists essentially of a thermal treatment. Advantageously, this step is performed under inert atmosphere, under a carrier gas atmosphere, like for example N₂, Ar, a mixture of Ar/H₂, at a temperature ranging from 500° C. to 700° C., preferably from 550° C. to 650° C., advantageously around 600° C.

According to a variant, the process according to the invention comprises an additional step (6) of washing the composite material obtained at the end of step (5).

The composite material obtained at the end of step (5) can be washed with an organic solvent, preferably chosen from: chloroform, ethanol, toluene, acetone, dichloromethane, petroleum ether and mixtures thereof.

Alternately, according to a favorite embodiment, the composite material obtained at the end of step (5) is washed with an acid solution, as illustrated in the experimental part (example 2).

According to this variant, preferably, after step (6), the process further comprises a supplementary step of drying the washed composite material.

Drying can be for example performed by placing the composite material into an oven, preferably at a temperature superior or equal to 40° C., more preferably superior or equal to 60° C.

Preferably, the drying step lasts from 15 minutes to 12 hours, more preferably from 2 hours to 10 hours, and even more preferably from 5 hours to 10 hours.

### The Precursor Compound of the Silicon Nanowires

The process according to the invention comprises the introduction into the chamber of the reactor, of at least one precursor compound of the silicon nanowires. By “precursor compound of silicon nanowires”, we refer to a compound capable of forming silicon nanowires by implementing the method according to the invention, especially a compound capable of forming silicon nanowires under CVD process conditions.

This compound can be introduced into the chamber of the reactor as a liquid or as a gas. When the compound is introduced into the chamber of the reactor as a liquid, it is transformed to the gas state in the reactor chamber, by controlling the temperature and the pressure in the chamber of the reactor. When the precursor compound of silicon nanowires is in a gas state, it is designated «reactive silicon-containing gas species».

For example, if the precursor compound of SiNWs is a liquid, like for example diphenylsilane, when the reactor reaches appropriate temperature/pressure parameters, the liquid precursor evaporates to a gas species.

The precursor compound of silicon nanowires can be introduced into the reactor as a gas in mixture with a carrier gas.

If the precursor compound is in the form of a reactive silicon-containing gas species, it can be introduced into the chamber of the reactor in mixture with a carrier gas (forming a reactive silicon-containing gas mixture). For example, SiH₄, a gas at ambient temperature/pressure, can be introduced directly into the chamber of the reactor alone or in mixture with a carrier gas. Alternately, a liquid precursor compound like diphenylsilane, Ph₂SiH₂, can be heated to be transformed to the vapour state in a preliminary stage of the process and then be introduced into the chamber of the reactor as a gas, alone or in mixture with a carrier gas.

Preferably, the precursor compound of silicon nanowires, or «reactive silicon-containing gas species», is a silane compound or a mixture of silane compounds.

For the purpose of the invention, the term “silane compound” refers to compounds of formula (I):

R₁—(SiR₂R₃)ₙ—R₄ (I)

wherein:
n is an integer ranging from 1 to 10, and
R₁, R₂, R₃ and R₄ are independently chosen from hydrogen, C₁-C₁₅ alkyl groups, C₆-C₁₂ aryl groups, C₇-C₂₀ aralkyl groups and chloride.

According to this embodiment, preferably, the silicon-containing gas species is chosen from compounds of formula (I) wherein:
n is an integer ranging from 1 to 5, and
R₁, R₂, R₃ and R₄ are independently chosen from hydrogen, C₁-C₃ alkyl groups, phenyl, and chloride.

Even more preferably, n is an integer ranging from 1 to 3, and R₁, R₂, R₃ and R₄ are independently chosen from hydrogen, methyl, phenyl, and chloride.

According to this embodiment, preferably, the precursor compound of silicon nanowires is chosen from silane, disilane, trisilane, chlorosilane, dichlorosilane, trichlorosilane, dichlorodimethylsilane, phenylsilane, diphenylsilane or triphenylsilane or a mixture thereof.

According to a preferred embodiment, the precursor compound of silicon nanowires is silane (SiH₄) or diphenylsilane Si(C₆H₅)₂H₂. The nature and physical state of the precursor compound of silicon nanowires is selected according to the type of reactor and the other parameters of the method.

### The Reactive Silicon-Containing Gas Mixture

The precursor compound of the silicon nanowires according to the invention can be introduced into the reactor as a gas, or as a liquid which is transformed to a gas in the reactor. The silicon nanowires are obtained from the chemical decomposition at high temperature of a reactive silicon-containing gas species, which may be in mixture with a carrier gas. This mixture is referred to hereinafter as «reactive silicon-containing gas mixture».

By “carrier gas”, we refer to a gas that is chosen from a reducing gas, an inert gas, or a mixture thereof.

Preferably, the reducing gas is hydrogen (H₂).

Preferably, the inert gas is chosen from argon (Ar), nitrogen (N₂), helium (He), or a mixture thereof.

According to a preferred embodiment, the silicon-containing gas mixture is composed of at least 1% by volume of silicon-containing gas species, preferably at least 10% by volume, more preferably at least 50% by volume, still more preferably 100% by volume.

The proportions of silicon-containing gas species and carrier gas can be modulated at different levels at different steps of the process.

### The Catalyst

The process according to the invention comprises the introduction into the chamber of the reactor of a SnX₂ catalyst, with X a halide selected from the group consisting of: F, Cl, Br and I.

In the context of the invention “catalyst” designates a compound selected from compounds of the formula SnX₂, with X a halide selected from the group consisting of: F, Cl, Br and I.

Preferably, in the context of the invention, “catalyst” designates SnCl₂. The function of the catalyst is to promote the growth of SiNWs. Preferably, SnX₂, especially SnCl₂, is under the form of particles.

The process according to the invention comprises a step of solid/solid mixing of the SnX₂ catalyst and the growth support.

For the purposes of the invention, the term “solid/solid mixing” means that the growth support material and the catalyst undergo an association and/or combination and/or blending step corresponding to mixing of the catalyst with the growth support as raw materials in the solid state in order to obtain a material of essentially homogeneous composition. The solid/solid mixing is performed in the absence of any medium or solvent.

According to a favourite embodiment of the invention, the mixture of the SnX₂, preferably SnCl₂, catalyst and the growth support is advantageously prepared before their introduction into the chamber of the reactor. The obtained solid mixture is then introduced into the chamber of the reactor and the steps (2) to (5) as disclosed above are implemented.

According to this embodiment, the solid/solid mixing can be implemented with any industrial mixing apparatus known to the skilled professional such as ball-milling, attrition-milling, hammer milling, high energy milling, pin-milling, turbo-milling, fine cutting milling, impact milling, fluidized bed milling, conical screw milling, rotor milling, agitated bead milling, or jet milling. Preferably, this step of the process does not take more than 30 minutes.

According to another favourite embodiment of the invention, the solid/solid mixing of the SnX₂, preferably SnCl₂, catalyst and the growth support is implemented in the chamber of the reactor after the introduction into the chamber of the reactor of the SnX₂ catalyst and the growth support as raw materials. According to this embodiment, the solid/solid mixing can, for example, be achieved through the mixing means and/or mechanism of the reactor. This can be the case, for example, when using a tumbler reactor with a rotating mechanism. Alternatively, the solid/solid mixing can be achieved by injecting an inert gas flow into the chamber of the reactor that can create a movement of particles by mechanical fluidization and thus their mixing.

According to the invention, the growth support material and the catalyst are associated before or after their introduction into the reactor.

For the purposes of the invention, the term “associated” means that the growth support material and the catalyst have undergone an association step corresponding to mixing of the catalyst with the growth support material in order to obtain a material of essentially homogeneous composition.

The combination of SnX₂, preferably SnCl₂, and the growth support, according to the invention, is simple and robust. SnCl₂, like the other tin halides, as raw materials being a very stable product allows an easier processing compared to other catalysts. Indeed, SnCl₂, like the other tin halides, only requires solid/solid mixing with the growth support, whereas the growth medium based, for example, on gold nanoparticles requires a solid/liquid preparation followed by an evaporation of solvents.

In case the growth support is a 2D support (ITO glass or Si wafers for example), advantageously, the solid/solid mixing results in a mixture of the catalyst and the growth support wherein the growth support is coated on part or all of its surface with the catalyst. This coating can be implemented for example by dropping off the catalyst powder on the support.

Preferably, the catalyst and the growth support material are used according to a mass ratio catalyst/growth support ranging from 0.01 to 1, more preferably from 0.02 to 0.5, and still more preferably from 0.05 to 0.15.

The step of solid/solid mixing of the catalyst with the growth support material according to the invention allows the formation of a plurality of particles growth sites on the surface of the growth support material.

### The Growth Support

The method according to the invention is implemented in presence of a growth support.

For example, the growth support can be a carbon-based material, a silicon-based material, an ITO based material, a carbonaceous polymer.

The growth support can be a 0D, 1D, 2D or 3D material.

For example, 0D materials could be silicon nanoparticles or carbon black nanoparticles.

For example, 1D materials could be carbonaceous polymer fibers or carbon nanotubes.

For example, 2D materials could be a silicon wafer, graphene, or an ITO glass.

For example, 3D materials could be powders such as silicon microparticles, graphite (natural, artificial or expanded), or fine graphite, or a carbonaceous medium such as a polymer material.

The silicon-based support may be any material selected from the group consisting of silicon nanoparticles, silicon microparticles, silicon wafers.

Preferably, silicon nanoparticles have a mean particle size from 1 to 100 nm, more preferably 30-50 nm.

Preferably, silicon microparticles have a mean particle size from 0.1 to 30 μm, advantageously from 1 to 15 μm.

Preferably, silicon wafers have a mean width size from 1 cm to 45 cm, advantageously from 1 to 10 cm. The ITO-based support may be any material selected from the group consisting of ITO glass have a mean width size from 1 cm to 100 cm, advantageously from 1 to 10 cm.

The carbon-based support may be any material selected from the group consisting of graphite, graphene, carbon, and more specifically natural graphite, artificial graphite, hard carbon, soft carbon, carbon nanotubes or amorphous carbon, carbon nanofibers, carbon black, expanded graphite, graphene or a mixture of two or more thereof.

The average particle size of the support may be measured by using a laser diffraction method.

In case the growth support is a carbon-based support, it can be under the form of particles, particulate agglomerates, non-agglomerated flakes, or agglomerated flakes.

According to this variant, advantageously, the carbon-based support has a Brunauer-Emmett-Teller (BET) surface ranging from 1 to 100 m²/g, more preferably in the range of 1-70 m²/g, even more preferably in the range of 3-50 m²/g.

According to a favourite embodiment of this variant, the carbon-based material is selected from graphite, graphene, carbon, preferably graphite powder with a mean particle size from 0.01 to 50 μm.

According to another variant, the growth support is a carbonaceous polymer material. The use of a polymer as growth support has been disclosed in WO2021018598

When the growth support is a carbonaceous polymer material, preferably, the polymer material has a decomposition temperature, determined by thermal gravimetric analysis, superior or equal to 200° C., preferably superior or equal to 300° C., more preferably superior or equal to 400° C., advantageously superior or equal to 500° C.

Advantageously, according to this variant, the polymer material is chosen from fibrous polymer materials of synthetic or natural origin, preferably from fibrous polymer materials of synthetic origin.

More advantageously, according to this variant, the polymer material is chosen from polybenzothiazoles, polyamines, polyimides, polyurethanes, polybenzoxazoles, polyamides, polybenzimidazoles and mixtures thereof, preferably chosen from polyamides.

Even more advantageously, according to this variant, the polymer material is poly-paraphenylene terephtalamide, also known as Kevlar®.

In case the growth support is a polymer material, the method according to the invention comprises:
i) preparing a composite material comprising a polymer material and SiNWs according to the process defined above, and
ii) carbonizing the polymer material of the polymeric composite material. Detailed process parameters appropriate to prepare a silicon/polymer composite material and a silicon/carbon composite material have been disclosed in WO2021018598.

It is possible to control the silicon nanowires' diameter via the growth support physical properties. This possibility is illustrated in the experimental part for 3D growth supports:

As noted in the experimental part, the nanowires' diameter prepared using SnCl₂ are directly impacted by the growth support material. Indeed, it has been observed that with an increase of the specific surface area (SSA>5 m²/g) of the growth support material, SiNWs present an average diameter around 80-90 nm. However, when the growth is made in presence of a growth support material with a lower specific surface area (SSA<5 m²/g), average diameters were found to be around 150-160 nm.

The morphology of the growth support material can also be used to control the nanowires' diameters. For example, expanded graphite gives access to SiNWs with an average diameter around 140 nm (example 3).

### Doping Material

According to one embodiment, the process according to the invention can comprise the introduction, into the reactor, of at least one doping material.

The term “doping material” is understood to mean, within the meaning of the invention, a material capable of modifying the conductivity properties of the silicon. A doping material within the meaning of the invention is, for example, a material rich in phosphorus, boron or also nitrogen atoms.

Preferentially, and according to this embodiment, the doping material is introduced into the chamber of the reactor by means of a precursor chosen from diphenylphosphine, triphenylborane and di- and triphenylamine. According to a first variant, this introduction is implemented before the growth of SiNWs has started.

According to another variant, the precursor of the doping material is introduced as a gas simultaneously with (and possibly as part of) the reactive silicon-containing gas mixture.

Preferably, the molar proportion of doping material, with respect to the precursor compound of the silicon nanowires, is from 10⁻⁴ molar % to 10 molar %, preferably from 10⁻² molar % to 1 molar %.

### The Reactor

According to a first variant, the method is implemented in a fixed-bed reactor.

According to a second variant, the method is implemented in the tubular chamber of a tumbler reactor comprising a rotating and/or a mixing mechanism.

### First Variant

According to a first variant, the method is implemented in a fixed-bed reactor.
Characteristics of the reactor:

The fixed-bed reactor is preferably a closed reactor.

A reactor which can be used to implement the method according to the invention is disclosed for example in WO2019020938. In this document, it is used in the “closed reactor” mode.
Parameters:

According to this first variant, the reactor is closed, decreasing the dioxygen content in the chamber of the reactor can be performed by placing the reactor under vacuum, preferably to a pressure inferior or equal to 10⁻¹ bar (10⁻² MPa).

Alternately, decreasing the dioxygen content in the chamber of the reactor can be performed by washing the chamber of the reactor with an inert gas.

In the context of the invention, the expression “washing the chamber of the reactor with an inert gas” means that an inert gas flow is injected into the chamber of the reactor in order to replace the gas present in the reactor by the injected inert gas.

Preferably, the inert gas is chosen from dinitrogen N₂, Argon Ar, and mixtures thereof. Preferably, the chamber of the reactor is washed at least twice, more preferably at least 3 times with inert gas.

Preferably, at the end of step (3), the dioxygen content in the chamber of the reactor is inferior or equal to 1% by volume, with respect to the total volume of the chamber of the reactor.

According to this variant, generally the precursor compound of the silicon nanowires is introduced into the reactor as a liquid.

According to this variant, the catalyst, the precursor compound of the silicon nanowires, and the growth support, can be introduced into the reactor in the form of a mixture.

According to this variant, preferably the reactor comprises at least two charging zones, a first zone which makes it possible to receive the precursor compound of the silicon nanowires and a second zone which makes it possible to receive the growth support and the catalyst.

According to an alternative form, the first charging zone and the second charging zone are located at the same level in the chamber of the reactor.

According to a preferred alternative form, the second charging zone is raised with respect to the first charging zone.
Steps of the process:

According to this variant, the process according to the invention advantageously comprises:
(1′) solid/solid mixing of the tin halide SnX₂ and the growth support in a mixing device,
(1) introducing into a chamber of a reactor the mixture resulting from step (1′),
(2) introducing, into the chamber of the reactor, at least one precursor compound of the silicon nanowires,
(3) decreasing the dioxygen content in the chamber of the reactor,
(4) applying a thermal treatment at a temperature ranging from 200° C. to 900° C., and
(5) recovering the product,

Wherein steps (1′) and (1) are implemented in the recited order, but steps (2), (3), and (4) can be implemented in this order or in another order.

### Second Variant

According to a second variant, the method according to the invention is implemented in the tubular chamber of a tumbler reactor comprising a rotating and/or a mixing mechanism.
Characteristics of the reactor:

The tumbler reactor here-above mentioned is composed of at least a tubular chamber, heated by a furnace, in which the growth support material and the tin halide catalyst can be loaded either as separate materials or as a mixture. The reactor integrates a rotating mechanism and/or a mixing mechanism. The reactor can comprise two tubular chambers. The tubular chamber longitudinal axis is horizontal or can be tilted to make an angle with the horizontal axis up to 20°. The reactor further comprises a product feeding system and a product discharge system, allowing a semi-continuous production of silicon-tin and growth support composite material. The tumbler reactor comprises a reactor pressure control device, like for example a needle valve, or a pressure controller.

A typical mechanical tumbler reactor is a Lödige's type fluidized-bed reactor, where fluidization is generated by the rotation of a horizontal axis helix in the tubular chamber.

Another typical mechanical tumbler reactor comprises a rotating tubular chamber where fluidization is generated by the rotation of the tubular chamber around its longitudinal axis.
Parameters:

This variant is of particular interest as fluidization mechanically generated by the reactor is beneficial to the contact between the growth support and the silicon comprising reactive gas species. This variant is also of particular interest since it permits the direct introduction of the catalyst and the growth support and their mixing in the chamber of the reactor.

According to this variant, preferably the precursor compound of the silicon nanowires is introduced into the reactor as a gas.
Steps of the process:

According to this variant, the process according to the invention advantageously comprises:
(1A) introducing into the tubular chamber of the reactor at least the SnX₂ catalyst, preferably the SnCl₂ catalyst, and optionally the growth support,
(1B) heating the tubular chamber under carrier gas flow,
(1′) rotating the tubular chamber and/or starting the mixing mechanism,
(2) introducing a reactive silicon-containing gas mixture into the tubular chamber,
(3) controlling the pressure in the chamber of the reactor with the gas mixture flow,
(4) applying a thermal treatment at a temperature ranging from 200° C. to 900° C., under reactive silicon-containing gas mixture flow, in the tubular chamber under rotation and/or mixing,
(5) recovering the obtained product,

According to this variant, most steps have to be accomplished according to this order, however, the rotation and/or mixing at step (1′) can start before or after step (1A) or step (1B).

It is understood that, alternatively, according to this variant, the process can be implemented by first solid/solid mixing of the SnX₂ catalyst, preferably the SnCl₂ catalyst, and the growth support prior to their introduction into the tubular chamber, and then implementing the same steps (1) to (5) as above recited.

At the end of step (4), the reactor can be opened and another iteration of steps (2), (3) and (4) can be implemented in order to continue SiNWs growth before the product is recovered.

According to this variant, the thermal treatment of step (4) is applied at low pressure (lower than atmospheric), or at atmospheric pressure or at a pressure superior to atmospheric.

Preferably, when the reactor is a tumbler reactor comprising a rotating and/or a mixing mechanism, the thermal treatment of step (4) is applied at a pressure superior to atmospheric.

### Material Composition:

The above disclosed method gives access to a composite material comprising, preferably consisting essentially of: the growth support, silicon nanowires and tin particles. The material may comprise halides, especially chloride, as traces.

Advantageously, in the composite obtained, Si content is superior to 5%, preferably superior to 20%, by weight of silicon, with regards to the total weight of the material.

Tin particles come from the decomposition of tin (II) halide, especially tin (II) chloride, during the reaction. The composite material preferably comprises tin particles in amounts ranging from 1% to 10% by weight of tin with regards to the total weight of the material, preferably ranging from 1% to 5% by weight.

Remaining tin (II) halide, especially tin chloride, can be partially removed by acidic treatment of the composite (see example 2 and ICP analysis).

By remaining tin (II) halide, especially tin chloride, we refer to the fact that not all tin (II) halide, reacts with silicon during the process. This observation is in adequacy with the study made by Dusanes et al., (10) (see details in Example 1.d), the rest of tin (II) halide, especially tin chloride, having reacted during the process has been transformed to Tin (metal) associated to SiNWs.

Traces of halide, especially chloride, can be found in the composite. Typical values are below 1% by weight of halide, especially chloride, with regards to the total weight of the material, preferably below 0.1% by weight.

The silicon material, resulting from chemical vapor decomposition of the silicon-containing gas species, can be under the form of wires, worms, rods or filaments.

According to a preferred embodiment, the silicon material is in the form of nanowires.

The term “nanowire” is understood to mean, within the meaning of the invention, an elongated element, the shape of which is similar to that of a wire and the diameter of which is nanometric.

Preferably, silicon nanowires have a diameter ranging from 1 nm to 250 nm, more preferentially ranging from 10 nm to 200 nm and more preferentially still ranging from 30 nm to 180 nm.

The size of the silicon material may be measured by several techniques well known by the skilled person such as for example by analysis of pictures obtained by scanning electron microscopy (SEM) from one or more samples of the carbon-silicon composite material.

Advantageously, silicon, preferably silicon nanowires, represents from 1% to 70% by weight with regards to the total weight of the silicon-based composite material, preferably from 10% to 70% by weight, more preferably from 20% to 70% by weight, even more preferably from 30% to 70% by weight, advantageously from 50% to 70% by weight.

The silicon-based composite material is preferably obtained in the form of a powder.

### Uses of the Silicon-Tin Composite Material

The silicon composite material according to the invention may be used as an anode active material and for the manufacture of a lithium-ion battery.

An electrode including a current collector is prepared by a preparation method classically used in the art. For example, the anode active material consisting in the silicon composite material of the present invention is mixed with a binder, a solvent, and a conductive agent. If necessary, a dispersant may be added. The mixture is stirred to prepare a slurry. Then, the current collector is coated with the slurry and pressed to prepare the anode.

Various types of binder polymers may be used as the binder in the present invention, such as a polyvinylidene fluoride-hexafluoropropylene copolymer (PVDF-co-HEP), polyvinylidene fluoride, polyacrylonitrile, and polymethylmethacrylate.

The electrode may be used to manufacture a lithium secondary battery including a separator and an electrolyte solution which are typically used in the art and disposed between the cathode and the anode.

### BRIEF DESCRIPTION OF THE DRAWINGS

FIG. 1 is a photograph obtained by scanning electron microscopy (SEM) of Si nanowires/KS4 graphite composite at low magnification (example 1)

FIG. 2 is a photograph obtained by scanning electron microscopy (SEM) of Si nanowires/KS4 graphite composite at high magnification (example 1)

FIG. 3 is a graphic representing the potential profile of the cell prepared from Si nanowires/KS4 graphite composite (example 1): X=capacity of the cell in mA.h, Y=potential of the cell in V

FIG. 4 is a graphic representing the derivatives plot of the potential profile of the cell prepared from Si nanowires/KS4 graphite composite (example 1): X=capacity of the cell in mA.h, Y=potential of the cell in V

FIG. 5 is a photograph obtained by scanning electron microscopy (SEM) of Si nanowires/KS4 composite after HCI washing step at low magnification (example 2)

FIG. 6 is a photograph obtained by scanning electron microscopy (SEM) of Si nanowires/KS4 graphite composite after HCI washing step at high magnification (example 2)

FIG. 7 is a graphic representing the potential profile of the cell prepared from Si nanowires/KS4 graphite composite after HCI washing step (example 2): X=capacity of the cell in mA.h, Y=potential of the cell in V

FIG. 8 is a photograph obtained by scanning electron microscopy (SEM) of Si nanowires/BNB90 graphite composite at low magnification (example 3)

FIG. 9 is a photograph obtained by scanning electron microscopy (SEM) of Si nanowires/BNB90 graphite composite at high magnification (example 3)

FIG. 10 is a graphic representing the potential profile of the cell prepared from Si nanowires/BNB90 graphite composite (example 3): X=capacity of the cell in mA.h, Y=potential of the cell in V

FIG. 11 is a photograph obtained by scanning electron microscopy (SEM) of Si nanowires/SLP50 graphite composite at low magnification (example 4)

FIG. 12 is a photograph obtained by scanning electron microscopy (SEM) of Si nanowires/SLP50 composite at high magnification (example 4)

FIG. 13 is a graphic representing the potential profile of the cell prepared from Si nanowires/SLP50 graphite composite (example 4): X=capacity of the cell in mA.h, Y=potential of the cell in V.

FIG. 14 is a photograph obtained by scanning electron microscopy (SEM) at low magnification of a Si nanowires/Si nanoparticles composite (example 5).

FIG. 15 is a photograph obtained by scanning electron microscopy (SEM) at high magnification of a Si nanowires/Si nanoparticles composite (example 5).

FIG. 16 shows the potential profile (X=capacity of the cell in mA.h, Y=potential of the cell in V) of the cell prepared from Si nanowires/Si nanoparticles composite (example 5).

FIG. 17 is a photograph obtained by scanning electron microscopy (SEM) at low magnification of a Si nanowires/tin/KS4 composite obtained by treatment with SiH₄ (example 6).

FIG. 18 is a photograph obtained by scanning electron microscopy (SEM) at high magnification of a Si nanowires/tin/KS4 composite obtained by treatment with SiH₄ (example 6).

### Experimental Part:

In the following examples, and unless otherwise indicated, the contents and percentages are given in mass.

### Material

Reactor (fixed bed): stainless steel reactor (intern volume=1 L, diameter=100 mm, height=125 mm).
ball-milling apparatus: Model PM100, commercialized by the company Retsch
silicon precursor: diphenylsilane Si(C₆H₅)₂H₂, commercialized by the company Sigma-Aldrich (CAS Number: 775-12-2),
catalyst: SnCl2 commercialized by the company Strem Chemicals.Inc
graphite growth support: BNB90 graphite (SSA=21.18 m²/g), KS4 graphite, (SSA=24.48 m²/g) and SLP50 graphite (SSA=4.97 m²/g) are commercialized by the company Imerys
Silicon NPs: having an average particle size≤50 nm commercialized by the company GetNanoMaterials under commercial reference Si-100
conductive fillers: graphite powder commercialized by the company Imerys under the name C-NERGY™ Actilion GHDR-15-4.
carbon black, commercialized by the company Imerys under the commercial reference Timcal C-NERGY C65 (CAS Number: 1333-86-4).
carboxymethylcellulose (CMC) commercialized by the company Alfa-Aesar (CAS Number: 9004-32-4).
styrene-butadiene rubber (SBR) commercialized by the company MTI Corporation (CAS Number: 9003-55-8).
electrolyte: lithium hexaflurorophosphate LiPF₆ (1M) dissolved in a mixture of ethylene carbonate (EC) and diethylcarbonate (DEC) (1:1 in volume) comprising 10% by weight of fluoroethylene carbonate (FEC) and 2% by weight of vinylene carbonate (additive), commercialized by the company Solvionic.

### Example 1: Synthesis of KS4 Graphite/Si NWs Composite Material (M1)

### a) Mixing KS4 Graphite and SnCl₂ as Pre-Catalyst Material

3 g of graphite KS4 is combined to 0.5 g of SnCl2 and introduced in a steel bowl of the ball-milling apparatus. Then, 40 g of 3 mm steel balls are introduced in the bowl before being tightly closed. The powders are mixed for 10 minutes 30 seconds at 400 rpm.

The pre-catalyst material is recovered by extracting the balls with a sieve.

### b) Growth of the Silicon Nanowires (Process 1)

The material obtained at the end of step a) is placed on a glass cup inside the fixed-bed reactor. 50 mL of diphenylsilane, Ph₂SiH₂, are then poured at the bottom of the reactor.

After sealing the reactor, gas lines and temperature heating elements are connected to the reactor. The reactor is then put under vacuum and purged several times with N₂ to decrease the oxygen level. Subsequently, the reactor is heated up by means of an electric resistance placed in contact with the exterior surface of the reactor. The heating cycle is as follows: a heating ramp of 30 minutes from 20° C. to 430° C., a plateau of 60 minutes at 430° C., the heating is stopped and then the reactor is cooled down to room temperature. The reactor is finally opened to recover the composite material.

### c) Post-Treatment of the Graphite/Tin/Silicon Composite Material (Process 2)

The carbonization of the organics resulting from Ph₂SiH₂ decomposition is performed by thermal treatment.

The composite material obtained at the end of Process 1 is placed in a crucible which is then introduced in a horizontal quartz tube furnace. The inlet of the furnace is connected to argon Ar and dihydrogen H₂ gas lines with controlled amounts in a ratio of 97.5:2.5 (v/v) that are continuously flowed over the material. Thermal treatments are performed with a heating ramp of 6° C./min up to a temperature equal to 600° C. for a duration of 2 h, followed by natural cooling. The furnace is finally opened to recover the composite M1.

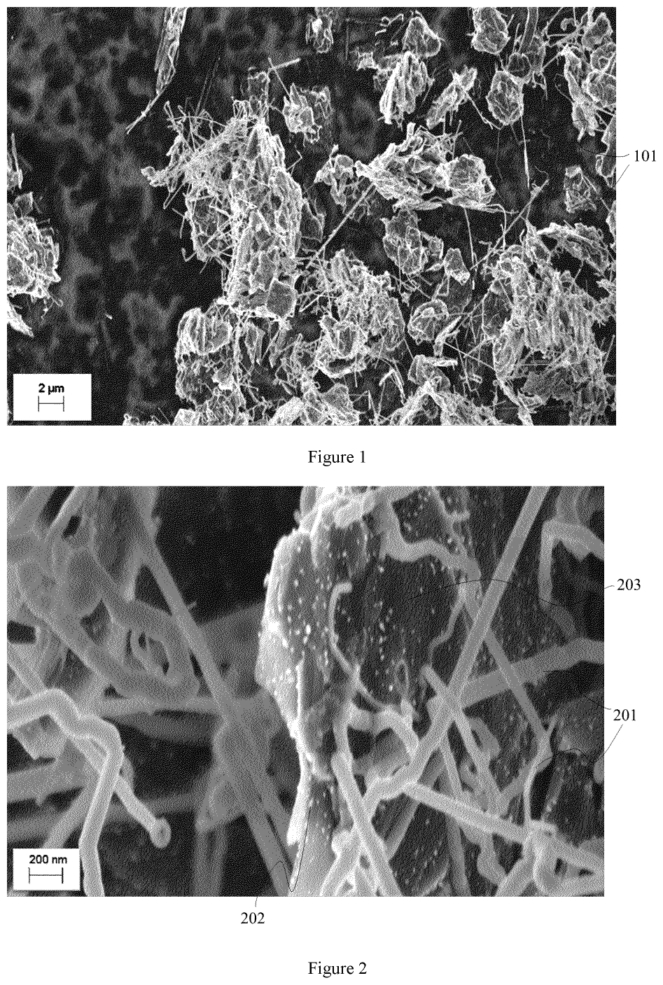

FIGS. 1 and 2 are SEMs micrographs of composite M1 with Si NWs 101 and 201 having a mean diameter of 80 nm.

### d) Description of FIG. 2

FIG. 2 shows a mixture of Si NWs 201 and small dots 202 dispersed onto the surface of the KS4 graphite 203. These small dots 202 are particles of Tin that have been too small to react with Si during the growth of Si NWs. This observation is in adequacy with the study made by Dusanes et al. (11).

### Example 2: Synthesis of “washed” KS4 Graphite/Tin/Silicon NWs Composite Material (M2)

Steps a), b) and c) are the same than Example 1

### d) Washing of the KS4 Graphite/Silicon Composite Material (Process 3)

10 g of the composite M1 are introduced in a beaker equipped with a magnet. Then 100 ml of HCl 5% vol are added to the beaker. The mixture is stirred for an hour at 600 rpm. After an hour, the mixture is filtered on a Buchner funnel equipped with a filter, then washed with distilled water until the pH is back to pH 6-7. Finally, the excess of water is removed by addition of ethanol. Then, the filter cake is dried overnight in a heat chamber at 60° C. in order to recover composite material M2.

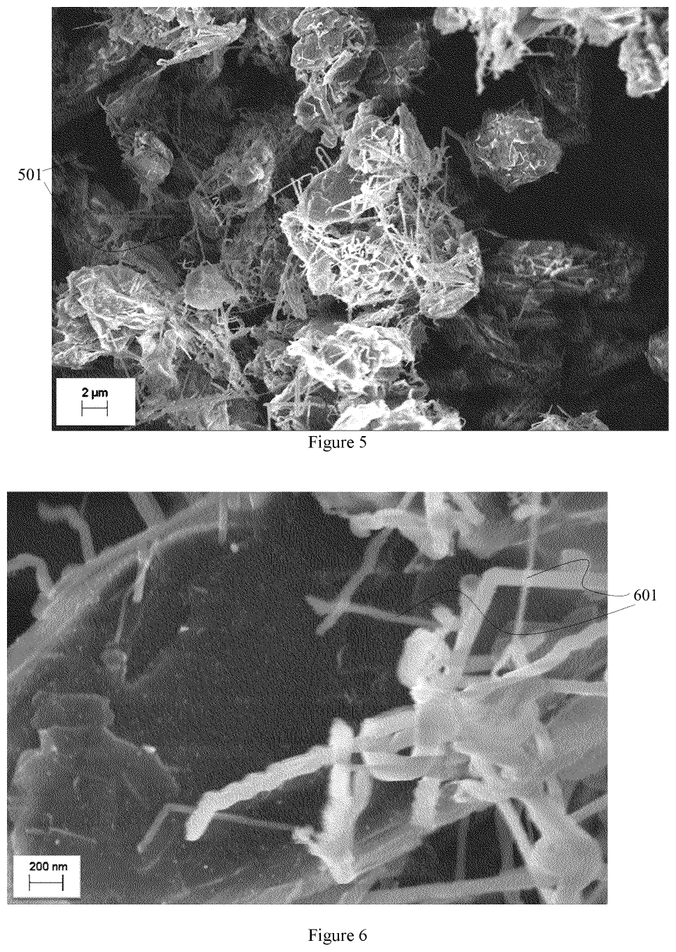

FIGS. 5 and 6 show composite material M3 with Si NWs 501 and 601 having a mean diameter of 80 nm.

### Example 3: Synthesis of BNB90 Graphite/Tin/Si NWs Composite Material (M3)

### a) Mixing BNB90 Graphite and SnCl₂ as Pre-Catalyst Material

3 g of BNB90 graphite is combined with 0.5 g of SnCl₂ and introduced in a steel bowl of the ball-milling apparatus. Then, 40 g of 3 mm steel balls are introduced in the bowl before being tightly closed. The graphite-SnCl₂ material is mixed for 10 minutes 30 seconds at 400 rpm.

The pre-catalyst material is recovered by extracting the balls with a sieve.

### b) Growth of the Silicon Nanowires (Process 1)

The pre-catalyst material obtained at the end of step a) is placed on a glass cup inside the fixed-bed reactor. 50 mL of diphenylsilane, Ph₂SiH₂, are then poured at the bottom of the reactor.

After sealing the reactor, gas lines and temperature heating elements are connected to the reactor. The reactor is then put under vacuum and purged several times with N₂ to decrease the oxygen level. Subsequently, the reactor is heated up by means of an electric resistance placed in contact with the exterior surface of the reactor. The heating cycle is as follows: a heating ramp of 30 minutes from 20° C. to 430° C., a plateau of 60 minutes at 430° C., heating is stopped and then the reactor is cooled down to room temperature. The reactor is finally opened to recover the composite material.

### c) Post-Treatment of the BNB90 Graphite/Tin/Silicon Composite Material (Process 2)

The carbonization of organics resulting from Ph₂SiH₂ decomposition is performed by thermal treatment.

The composite material obtained at the end of Process 1 is placed in a crucible which is then introduced in a horizontal quartz tube furnace. The inlet of the furnace is connected to argon Ar and dihydrogen H₂ gas lines with controlled amounts in a ratio of 97.5:2.5 (v/v) that are continuously flowed over the material. Thermal treatments are performed with a heating ramp of 6° C./min up to a temperature equal to 600° C. for a duration of 2 h, followed by natural cooling. The furnace is finally opened to recover the composite M3.

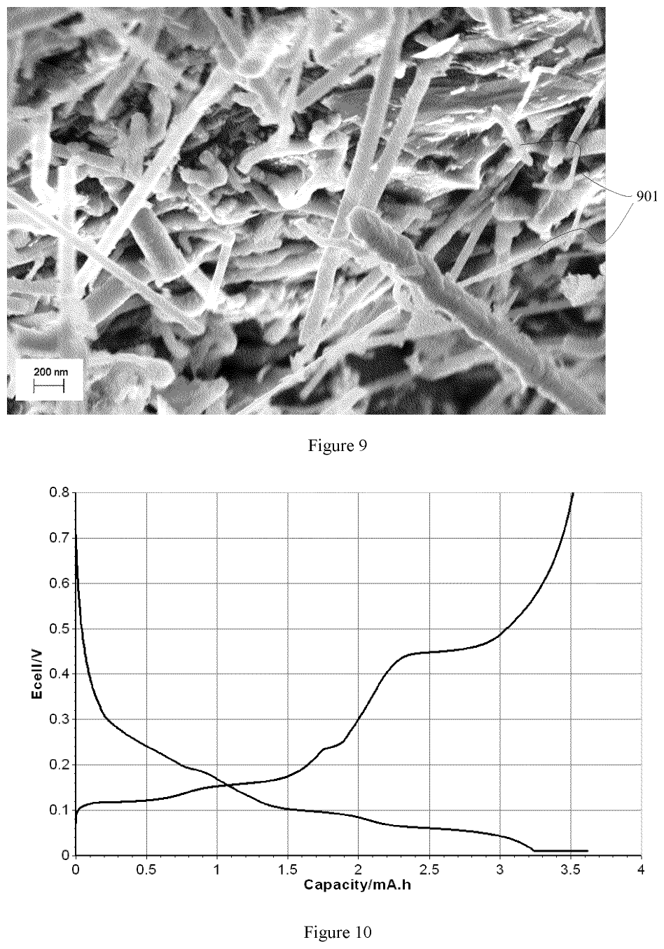

FIGS. 8 and 9 shows composite material M3 with Si NWs 801 and 901 having a mean diameter of 145 nm on BNB90 graphite 802.

Table 1 illustrates the ICP analysis of Si nanowires/KS4 composite from Example 1 (no post-treatment) and from Example 3 (after HCl washing step):

TABLE 1

| Composite | Si (% wt) | C (% wt) | Sn (% wt) | Cl (% wt) | O (% wt) |
|---|---|---|---|---|---|
| M1 | 20 | 71 | 4.4 | 0.02 | 5.6 |
| M3 | 20.8 | 70 | 2.28 | 0.007 | 5.7 |

### Example 4: Synthesis of SLP50 Graphite/Tin/Si NWs Composite Material (M4)

### a) Mixing SLP50 Graphite and SnCl₂ as Pre-Catalyst Material

3 g of SLP50 graphite is combined to 0.5 g of SnCl₂ and introduced in a steel bowl of the ball-milling apparatus. Then, 40 g of 3 mm steel balls are introduced into the bowl before being tightly closed. The SLP50-SnCl₂ material is mixed for 10 minutes 30 seconds at 400 rpm.

The pre-catalyst material is recovered by extracting the balls with a sieve.

### b) Growth of the Silicon Nanowires (Process 1)

The pre-catalyst material obtained at the end of step a) is placed on a glass cup inside the fixed-bed reactor. 50 mL of diphenylsilane, Ph₂SiH₂, are then poured at the bottom of the reactor.

After sealing the reactor, gas lines and temperature heating elements are connected to the reactor. The reactor is then put under vacuum and purged several times with N₂ to decrease the oxygen level. Subsequently, the reactor is heated up by means of an electric resistance placed in contact with the exterior surface of the reactor. The heating cycle is as follows: a heating ramp of 30 minutes from 20° C. to 430° C., a plateau of 60 minutes at 430° C., heating is stopped and then the reactor is cooled down to room temperature. The reactor is finally opened to recover the composite material.

### c) Post-Treatment of the SLP50 Graphite/Tin/Silicon Composite Material (Process 2)

The carbonization of organics coming from Ph₂SiH₂ decomposition is performed by thermal treatment.

The composite material obtained at the end of Process 1 is placed in a crucible which is then introduced in a horizontal quartz tube furnace. The inlet of the furnace is connected to argon Ar and dihydrogen H₂ gas lines with controlled amounts in a ratio of 97.5:2.5 (v/v) that are continuously flowed over the material. Thermal treatments are performed with a heating ramp of 6° C./min up to a temperature equal to 600° C. for a duration of 2 h, followed by natural cooling. The furnace is finally opened to recover the composite M4.

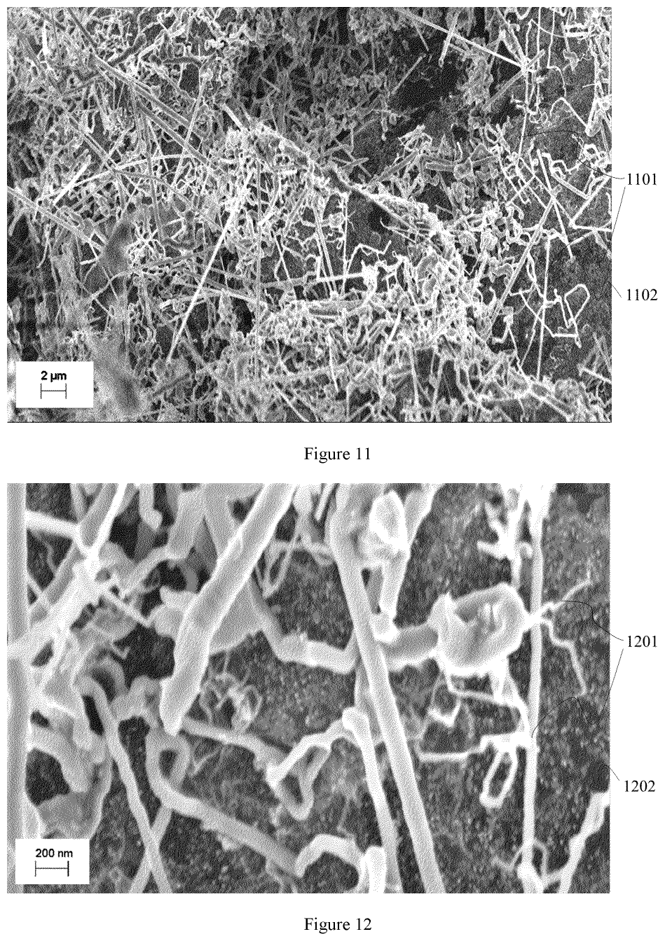

FIGS. 11 and 12 show composite material M4 with Si NWs 1101 and 1201 having a mean diameter of 158 nm on SLP50 graphite 1102 and 1202.

### Example 5: Synthesis of Silicon NPs/Tin/Silicon NWs Composite Material (M5)

### a) Mixing Si Nanoparticles and SnCl₂ as Pre-Catalyst Material

1 g of Silicon NPs is combined with 190 mg of SnCl₂ and introduced in a zirconia bowl of the ball-milling apparatus. Then, 10 mm zirconia balls are introduced in the bowl before being tightly closed. The Si NPs-SnCl₂ material is mixed for 10 minutes 30 seconds at 400 rpm.

The pre-catalyst material is recovered by extracting the balls with a sieve.

### b) Growth of the Silicon Nanowires (Process 1)

The pre-catalyst material obtained at the end of step a) is placed on a glass cup inside the fixed-bed reactor. 50 mL of diphenylsilane, Ph₂SiH₂, are then poured at the bottom of the reactor.

After sealing the reactor, gas lines and temperature heating elements are connected to the reactor. The reactor is then put under vacuum and purged several times with N₂ to decrease the oxygen level. Subsequently, the reactor is heated up by means of an electric resistance placed in contact with the exterior surface of the reactor. The heating cycle is as follows: a heating ramp of 30 minutes from 20° C. to 430° C., a plateau of 60 minutes at 430° C., heating is stopped and then the reactor is cooled down to room temperature. The reactor is finally opened to recover the composite material.

### c) Post-Treatment of the Si Nanoparticles/Tin/Silicon Composite Material (Process 2)

The carbonization of organics resulting from Ph₂SiH₂ decomposition is performed by thermal treatment.

The composite material obtained at the end of Process 1 is placed in a crucible which is then introduced in a horizontal quartz tube furnace. The inlet of the furnace is connected to argon Ar and dihydrogen H₂ gas lines with controlled amounts in a ratio of 97.5:2.5 (v/v) that are continuously flowed over the material. Thermal treatments are performed with a heating ramp of 6° C./min up to a temperature equal to 600° C. for a duration of 2 h, followed by natural cooling. The furnace is finally opened to recover the composite M5.

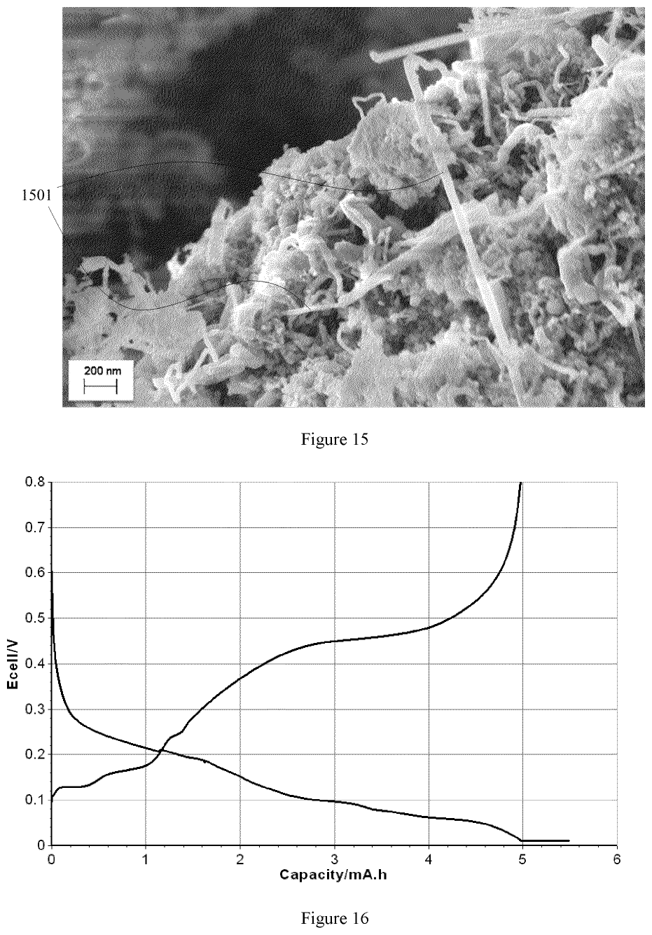

FIGS. 14 and 15 show composite material M5 with Si NWs 1401 and 1501 having a mean diameter of 165 nm.

### Example 6: Synthesis of KS4 Graphite/Tin/Si NWS Composite Material (M6)

### a) Mixing KS4 Graphite and SnCl₂ as Pre-Catalyst Material

35 g of SLP50 graphite is combined to 2.73 g of SnCl₂ and introduced in a steel bowl of the ball-milling apparatus. Then, 50 steel balls of 10 mm are introduced into the bowl before being tightly closed. The KS4-SnCl₂ material is mixed for 20 minutes 30 seconds at 300 rpm.

The pre-catalyst material is recovered by extracting the balls with a sieve.

### b) Growth of the Silicon Nanowires (Process 1)

The pre-catalyst material obtained at the end of step a) is placed homogeneously in a quartz tube inside the fixed-bed reactor.

After connecting the gas line to the reactor and closing the heating chamber, the quartz tube is flushed with N₂ at 5 slm for several minutes to decrease the oxygen level. Subsequently, the reactor is heated up by means of the heating device placed in contact with the exterior surface of the quartz tube. The heating and gas injection cycles are as follows: a heating ramp of 1 h from 20° C. to 650° C. under 5 slm Ar/H₂ 2.5% gas flow rate, a plateau of 4,3 hours at 650° C. under 5 slm N₂/SiH₄ 0.9% (L/min), heating is stopped and then the reactor is cooled down to room temperature under 5 slm N₂ gas flow rate. The reactor is finally opened to recover the composite material.

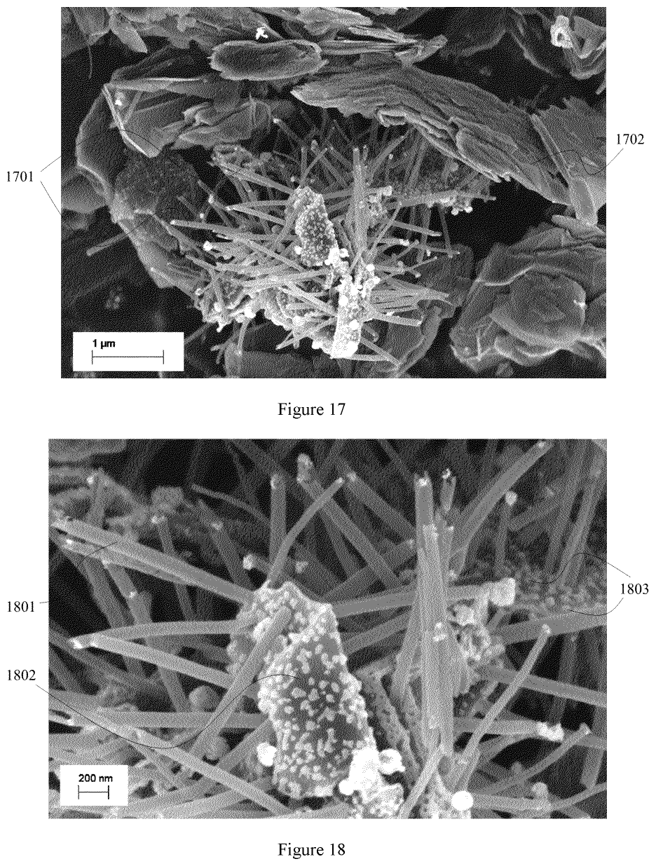

FIGS. 17 and 18 shows SEM micrograph of the Si nanowires/tin/KS4 composite M6 obtained in this example.

### c) Description of FIGS. 17 and 18

FIGS. 17 and 18 show a mixture of Si NWs 1701 and 1801 and small dots 1803 dispersed onto the surface of the KS4 graphite 1702 and 1802. These small dots 1803 are particles of Tin that have been too small to react with Si during the growth of Si NWs. This observation is in adequacy with the study made by Dusanes et al. (11).

### Example 7: Preparation of the Electrodes for Lithium Batteries

The electrochemical characterization of materials M1, M2, M3, M4 and M5 is performed by preparing coin-cells wherein the anode comprises one of the prepared materials as active material.

a) Mixing with Conductive Fillers

The composite material according to the invention M1, M2, M3, M4 or M5, is mixed with graphite powder using YSZ 3 mm diameter grinding balls, in an IKA® Ultra-Turrax disperser.

The composite material and the graphite are introduced into the disperser according to a weight ratio equal to 38:62.

Mixing is performed for 10 minutes at rotational speed 7.

The mixed material is finally recovered for further processing or characterization.

### b) Preparation of a Coin-Cell

The synthesized material was mixed with graphite powder (Actilion GHDR-15-4) at a ratio of ca. 38:62. A reference graphite electrode of Actilion material was made using pure graphite as the active material. For both systems, carbon black C-NERGY C65 was added as an electronic conductive additive, sodium carboxymethyl cellulose (Na-CMC) with styrene-butadiene rubber (SBR) were used as binders, and deionized water was employed as solvent. The weight ratios are 95:1:4 for the active material:C65:binders. Water is added to reach a viscosity allowing electrode processing, yielding to a dry content of about 40 wt %. Wet mixing was performed for 30 minutes at speed 5. Each electrode ink was cast on a copper foil of 20 μm. After drying in air, the electrodes were further dried at 65° C. in an oven for 2 hours. The electrodes were then cut into discs of 14 mm diameter, calendered at ca. 1 t/cm² and weighted, and were finally dried overnight in vacuum at 110° C.

Half coin-cells (Kanematsu KGK Corp®, stainless steel 316L) were prepared inside an Ar glovebox using metallic Li as counter and reference electrodes, a layer of Whatman glass fiber and a layer of Celgard 2325 separator, and the electrode of interest. The electrolyte used to impregnate the electrode and separator materials was 1 M LiPF₆ dissolved in EC:DEC (1/1 v/v) with 10 wt % FEC (fluoroethylene carbonate) and 2 wt % VC (vinylene carbonate) additives. The cell was subsequently sealed with an automated press and taken out of the glovebox to be measured on a battery cycler. Seven formation cycles were performed prior to regular cycling at 1 C-rate. The formation cycles are made of 2 cycles at C/10 and 5 cycles at C/5 using galvanostatic and potentiostatic discharging (lithiation), and galvanostatic charging (delithiation).

### c) Determination of the Electrochemical Performances

The performances of the cells are determined by galvanostatic cycling using a Biologic BCS-805 cycling system equipped with 8 ways, each of the 8 ways comprising 2 different electrodes.

### 1—Potential Profile

The potential profile of the cells C1, C2, C3, C4 and C5 has been determined during the cycling at C/10 by measuring the potential of the cell as a function of its capacity.

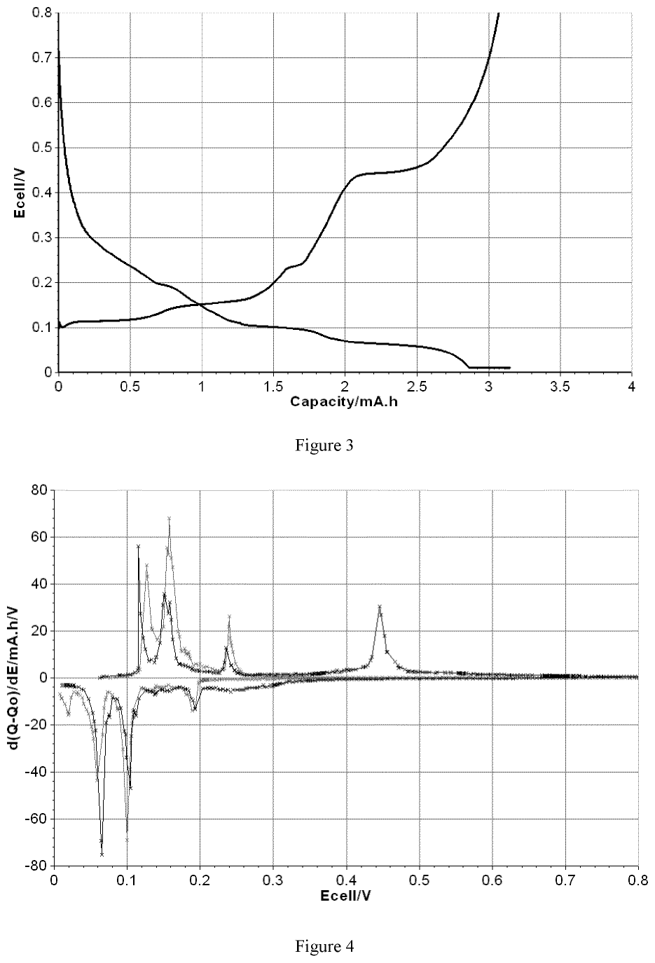

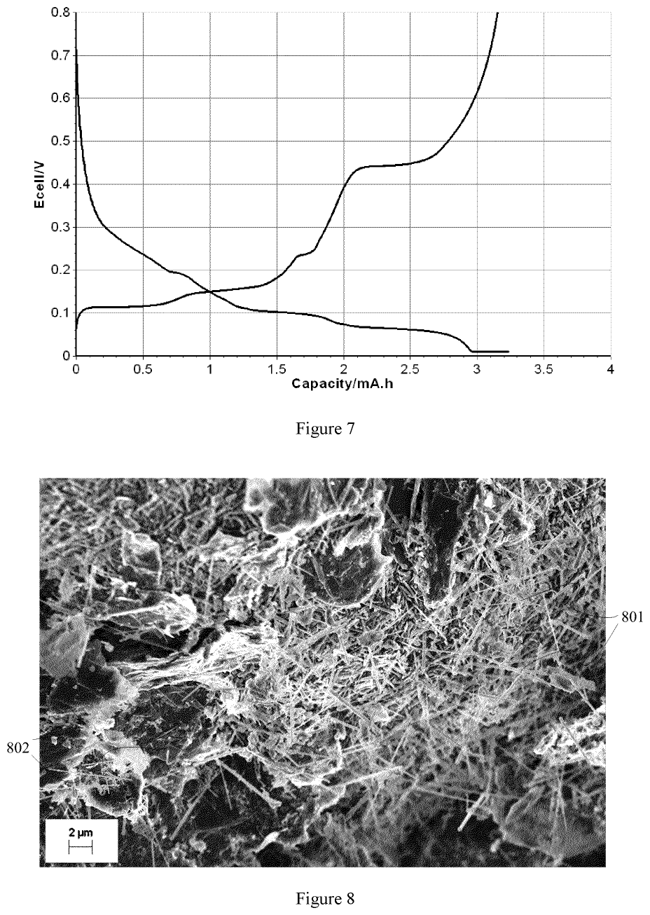

FIGS. 3, 7, 10, 13 and 16 represent the potential profiles obtained respectively from cells C1, C2, C3, C4 and C5 recorded during the second cycle at C/10 (third formation cycle).

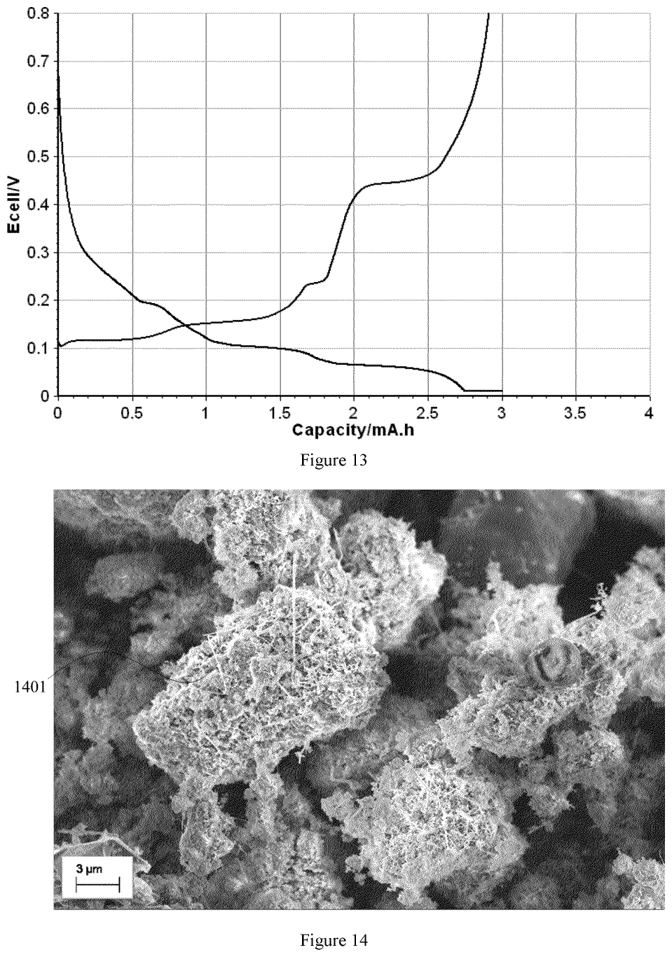

On FIGS. 3, 7, 10 and 13, the potential profiles of the cells obtained from composite Materials M1, M2, M3, M4 show the cumulation of the electrochemical activity of graphite and silicon materials, which evidences that the composite materials are electrically and electrochemically active. The electrochemical activity of silicon with lithium ions is highlighted by the inflexion/pseudo-plateau near 0.45 V during charge (delithiation), as is also clearly visible in the derivative plot (FIG. 13) of the capacity comparing a profile of a graphite electrode to that of a Si-graphite composite.

On FIG. 16, similarly to the other materials, the composite material M5 shows the cumulation of the electrochemical activity of the growth support, Silicon nanoparticules, and the silicon NWs material which evidences that the composite is electrically and electrochemically active as Li-ion anode material. The electrochemical activity of silicon with lithium ions is particularly highlighted by the inflexion/pseudo-plateau near 0.45 V during charge (delithiation).

### 2—Initial Reversible Capacity

The initial reversible capacity of the cells, measured at C/10 during the first cycle, is given in the Table 2.

TABLE 2

| Cell | C1 | C2 | C3 | C4 | C5 |
|---|---|---|---|---|---|
| Initial capacity (mA · h/g) | 822 | 872 | 864 | 713 | 1869 |

Cell C1, prepared from composite Material M1, and cell C2, prepared from composite Material M2, have similar initial reversible capacities. Therefore, composite Material M1 and composite Material M2 have the same silicon active content (ca. 20%). However, the initial capacity is increased for Material M2 compared to Material M1 due to the acidic washing that has been performed. Indeed, the purification of the material from the presence of potentially inhibiting compounds such as unreacted SnCl₂, SnOₓ or SiO₂, improves the initial capacity.

Moreover, a comparison of cells C1, C3 and C4 reveals an improvement of the initial capacity when the silicon active content increases (respectively 822 mA.h/g for ca. 15% vs. 864 mA.h/g for ca. 16% vs. 713 mA.h/g for ca. 11%), in composite Material M1 vs. composite Material M3 and composite Material M4.

Overall, these results demonstrate that the specific surface area and the morphology of the growth support permit to tune the growth ratio of Si NWs on the growth support and allow control of the electrical and electrochemical performances of the composite materials.

### REFERENCES

(1) S.-T. Lee et al., Nano Today, 2013, 8, 75-97
(2) S. Sadki et al., Nanoscale Res. Lett., 2013, 8, 1-5
(3) P. Yang et al., Nature, 2008, 451, 163-167
(4) Jeon et al., Materials Letters 63 (2009) 777-779
(5) Ball et al., CrystEngComm 15 (2013) 3808-3815
(6) Dai et al., Nanotechnology 29 (2018) 435301
(7) Ngo et al., MRS Proceedings 1258 (2010) 1258-P04-51
(8) Chockla et al., Chemistry of Materials 24 (2012) 3738-3745
(9) Gerrard E. J. Poinern et al., Journal of Colloid and Interface Science 352 (2010) 259-264
(10) Dusanes et al., J Nanopart Res, 2020, 22,363.

1-14. (canceled)

15. A method for the preparation of a composite material comprising at least silicon nanowires and tin, comprising at least the following stages:
(1) introducing into a chamber of a reactor at least:
a tin halide SnX₂, with X selected from: F, Cl, Br, I, and
a growth support,
(1′) solid/solid mixing of the tin halide SnX₂ and the growth support,
(2) introducing, into the chamber of the reactor, at least one precursor compound of the silicon nanowires,
(3) decreasing the dioxygen content in the chamber of the reactor,
(4) applying a thermal treatment at a temperature ranging from 200° C. to 900° C., and
(5) recovering the product,
wherein steps (1), (1′), (2), (3), and (4) can be implemented in this order or in another order.

16. The method of claim 15, wherein it is implemented in a fixed-bed reactor.

17. The method of claim 15, wherein it is implemented in the tubular chamber of a tumbler reactor set in motion by a rotating and/or a mixing mechanism.

18. The method as claimed in claim 15, wherein the tin halide is SnCl₂.

19. The method as claimed in claim 15, wherein the tin halide and the growth support are mixed together before their introduction into the reactor.

20. The method as claimed in claim 15, wherein the thermal treatment is performed at a temperature ranging from 200° C. to 900° C.

21. The method as claimed in claim 20, wherein the thermal treatment is performed at a temperature ranging from 300° C. to 650° C.

22. The method as claimed in claim 15, wherein the thermal treatment is applied from 1 minute to 5 hours.

23. The method as claimed in claim 22, wherein the thermal treatment is applied from 10 minutes to 2 hours.

24. The method as claimed in claim 15, wherein it comprises a post-treatment step in order to transform organics, resulting from the precursor compound of the silicon nanowires, into carbon materials.

25. The method as claimed in claim 15, wherein it comprises an additional step (6) of treating the composite material obtained at the end of step (5) with an acidic solution.

26. The method as claimed in claim 15, wherein the precursor compound of the silicon nanowires is a silane compound or a mixture of silane compounds.

27. The method as claimed in claim 26, wherein the precursor compound of the silicon nanowires is silane SiH4 or diphenylsilane Si(C₆H₅)₂H₂.

28. The method as claimed in claim 15, wherein the growth support is a carbon-based material, a silicon-based material, an ITO based material, or a carbonaceous polymer.

29. A method of making an electrode including a current collector, said method comprising (i) implementing the method of claim 15 to prepare composite material comprising at least silicon nanowires and tin, as an electrode active material, and (ii) covering at least one surface of the current collector with a composition comprising said electrode active material.

30. A method of making an energy storage device including a cathode, an anode, and a separator disposed between the cathode and the anode, wherein said method comprises implementing the method of claim 29 to make at least one of the electrodes.
